(19) United States
(12) Patent Application Publication
(10) Pub. No.: US 2013/0086536 A1
(43) Pub. Date: Apr. 4, 2013

(54) METHOD OF GENERATING STANDARD CELL LIBRARY FOR DPL PROCESS AND METHODS OF PRODUCING A DPL MASK AND CIRCUIT PATTERN USING THE SAME

(71) Applicants: WOOK KIM, YONGIN-SI (KR); HYUNG OCK KIM, SEOUL (KR); JUNG YUN CHOI, HWASEONG-SI (KR); KEE SUP KIM, HWASEONG-SI (KR); HYO SIG WON, SUWON-SI (KR)

(72) Inventors: WOOK KIM, YONGIN-SI (KR); HYUNG OCK KIM, SEOUL (KR); JUNG YUN CHOI, HWASEONG-SI (KR); KEE SUP KIM, HWASEONG-SI (KR); HYO SIG WON, SUWON-SI (KR)

(73) Assignee: SAMSUNG ELECTRONICS CO., LTD., SUWON-SI (KR)

(21) Appl. No.: 13/616,507

(22) Filed: Sep. 14, 2012

(30) Foreign Application Priority Data
Sep. 30, 2011 (KR) 10-2011-0099966

(51) Int. Cl. G06F 17/50

(52) U.S. Cl. 716/55

(57) ABSTRACT

A method of constructing a standard cell library for double patterning lithography (DPL) includes dividing a standard cell into a first region determined not to have an interaction with an adjacent outer cell and a second region that is likely to have such an interaction, generating data representative of DPL patterns corresponding to the first and second regions, and generating a standard cell library made up of the data. The library is then accessed and used to form a DPL mask. The DPL mask can be used to form a pattern on a substrate made up of a layout of cells in which the pattern of the standard cell is duplicated at several locations in the layout.

### PRIORITY STATEMENT

This application claims priority under 35 U.S.C. §119(a) from Korean Patent Application No. 10-2011-0099966 filed on Sep. 30, 2011, the disclosure of which is hereby incorporated by reference in its entirety.

### BACKGROUND

The inventive concept relates to the forming of patterns, such as circuit patterns, of semiconductor devices. More particularly, the inventive concept relates to double patterning lithography (DPL) for patterning a target layer/substrate, and to a method of fabricating a DPL mask for use in DPL.

The manufacturing of semiconductor devices entails the designing of a layout of elements and/or wiring (e.g., ICs) of the devices. The time and cost associated with the design process for the layout has increased with the rapid development of high-density semiconductor devices, i.e., devices having large numbers of elements and fine wiring patterns in a relatively small area. In this respect, a standard-cell-based layout design methodology has been developed. In standard-cell-based layout design methodology, elements such as a NOR gate or an AND gate having a pattern made up of several features, and which are typically used in multiples throughout a semiconductor device, are designed and designated as “standard cells” and stored in a library of a computer system in advance. Thus, the numerous features of these standard cells can be quickly laid out at the locations of the standard cells by a program accessing the library during the layout design process, so as to minimize the time it takes to complete the design of the layout of all of the cells (patterns) of the semiconductor device.

Meanwhile, double patterning lithography (DPL) has been developed to produce fine patterns whose density exceeds that which can be attained using conventional lithography due to limits of the resolution of the conventional lithography. In DPL, a mask pattern designed to produce the desired pattern of the device is broken down into two not so fine patterns, the two patterns are formed separately using conventional lithography processes, and a layer is etched using the two patterns as a mask. Therefore, the resolution of the conventional lithography process can in effect be doubled. Both standard-cell-based layout design methodology and DPL can be used together, but forming a standard cell using DPL may give rise to conflicts within the portions of the DPL mask used to form the standard cell and cells adjacent to the standard cell.

### SUMMARY

According to an aspect of the inventive concept, there is provided a method of generating a standard cell library for double patterning lithography (DPL), in which a pattern of a standard cell, that is to occur in multiples in a device to be fabricated using a DPL process, is analyzed to yield a first region and a second region of the standard cell. The first region is one having a pattern that can be produced by a DPL process without conflicting with the production of any respective one of several different patterns of outer cells each of which can be produced adjacent the standard cell during the DPL process, and the second region is one having a pattern that when produced by the DPL process has a substantial likelihood of conflicting with the production of any of the several different patterns of the outer cells when produced adjacent the standard cell during the DPL process. Then data representative of DPL patterns corresponding to each of the first and second regions is generated. Also, a standard cell library comprising the data representative of the DPL patterns is created.

The operation of dividing the standard cell may include dividing the standard cell into the first region and the second region, which is positioned surrounding the first region or positioned on the left and right sides of the first region.

According to another aspect of the inventive concept, there is provided a method of producing a double patterning lithography (DPL) mask in which a cell library having data representative of DPL patterns corresponding to patterns of first and second regions of a standard cell is provided and accessed. Data representative of a first DPL pattern corresponding to the pattern of a first region of a standard cell is selected from the cell library, and a position of where the first DPL pattern is to be produced on an underlying layer in a DPL process for forming respective patterns of cells of the device is determined. Data representative of a second DPL pattern corresponding to the pattern of a second region of the standard cell from the cell library is selected, and a position of where the second DPL pattern is to be produced on the underlying layer in the DPL process is determined. Also, a position of where a third DPL pattern, corresponding to the pattern of another cell is to be produced on the underlying layer in the DPL process, is determined. Then a DPL mask comprising the first, second and third DPL patterns is formed on the underlying layer, by forming a first mask pattern on the underlying layer and subsequently forming a second mask pattern on the underlying layer.

According to still another aspect of the inventive concept, there is provided a method of forming a pattern on a surface of a substrate, in which a layout of cells each having a pattern is created, wherein the cells include a standard cell whose pattern is duplicated at several locations in the layout, and another cell whose pattern exists adjacent one of the patterns of the standard cell in the layout, a cell library having data representative of DPL patterns corresponding to patterns of first and second regions of the standard cell is provided, data representative of a first DPL pattern corresponding to the pattern of a first region of the standard cell is selected from the cell library, and several relative positions of where the first DPL pattern is to be produced on an underlying layer in a DPL process for forming the layout of cells are determined. Data representative of a second DPL pattern corresponding to the pattern of a second region of the standard cell is selected from the cell library based on the pattern of the other cell, and a relative position of where the second DPL pattern is to be produced on the underlying layer in the DPL process is determined. Also, a relative position of where a third DPL pattern corresponding to the pattern of the other cell is to be produced on the underlying layer in the DPL process is determined. Then, the DPL process is performed. More specifically, the first, second and third DPL patterns are formed relative to one other at the predetermined positions on the underlying layer, respectively, and the underlying layer is etched. In this respect, the first, second and third DPL patterns are formed by forming a first mask pattern on the underlying layer and subsequently forming a second mask pattern on the underlying layer.

### BRIEF DESCRIPTION OF THE DRAWINGS

The above and other features and advantages of the inventive concept will become more apparent from the following detailed description of the preferred embodiments thereof made with reference to the attached drawings in which:

FIG. 1 is a schematic diagram of an example of a layout of cells, including a standard cell, of a semiconductor device showing the double patterning lithography (DPL) mask pattern used to form the standard cell;

FIG. 2 is a block diagram of a layout generator for generating a standard cell library for use in double patterning lithography (DPL) according to the inventive concept;

FIG. 3 is a flowchart of a method of generating a standard cell library for DPL according to the inventive concept;

FIGS. 4A through 4D are each a diagram of layout of cells and in which DPL patterns for producing the patterns of standard cells are overlaid on the patterns, and show an example of the method of FIG. 3 of producing the standard cell library;

FIGS. 5A and 5B are schematic diagrams of layouts of cells, respectively, showing examples of different ways in which a standard cell may be divided into regions in a method of generating a standard cell library for DPL according to the inventive concept;

FIG. 6A is a schematic diagram of a layout of cells and shows the DPL pattern for producing the standard cell overlaid on the pattern of the standard cell;

FIG. 6B is an enlarged view of region 660 in FIG. 6A and shows a stitching technique that may be employed by the method of generating a standard cell library for DPL according to the inventive concept;

FIG. 7 is a flowchart of a method of fabricating a DPL mask using a standard cell library for DPL according to the inventive concept; and

FIGS. 8 is schematic diagram of a double exposure process using a DPL mask produced using a DPL library, according to the inventive concept.

### DETAILED DESCRIPTION OF THE PREFERRED EMBODIMENTS

Various embodiments and examples of embodiments of the inventive concept will be described more fully hereinafter with reference to the accompanying drawings. In the drawings, the sizes and relative sizes and shapes of elements, layers and regions shown in section may be exaggerated for clarity. In particular, the cross-sectional illustrations of devices and intermediate structures fabricated during the course of their manufacture are schematic. Also, like and similar numerals are used to designate like and similar elements/features throughout the drawings.

Other terminology used herein for the purpose of describing particular examples or embodiments of the inventive concept is to be taken in context. For example, the terms “comprises” or “comprising” when used in this specification specifies the presence of stated features or processes but does not preclude the presence or additional features or processes. The term “pattern” will generally refer to a feature produced as the result of a patterning process, or a series of such features regardless of whether those features are similar and/or have a regular spacing. Also, the term “corresponding” may be used to indicate that two patterns are essentially similar or that at least one pattern is produced directly from the other.

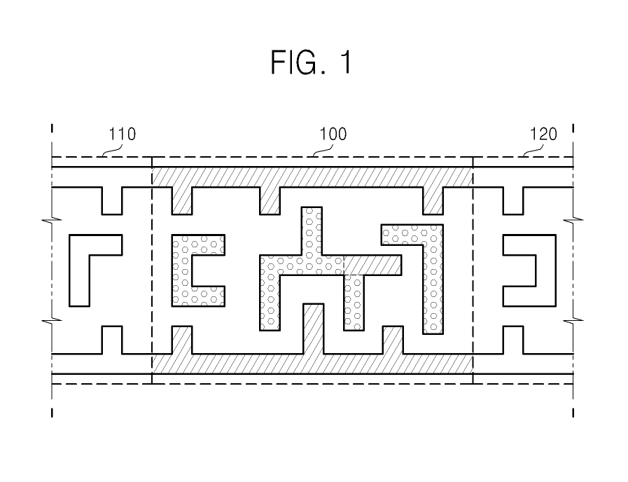

An example of a layout of cells, including a standard cell 100, as the result of a design process for use in manufacturing a semiconductor device is shown in FIG. 1. Also, in FIG. 1, a double patterning lithography (DPL) pattern by which the pattern of the standard cell 100 can be formed is shown as overlaid on the pattern of the standard cell.

In general, the standard cell 100 is laid out between outer (adjacent) cells 110 and 120 in the design process, but the separation of the mask pattern into two patterns (represented by the different forms of hatching in FIG. 1) for producing the standard cell 100, i.e., the designing of the (DPL) pattern, is usually carried out in advance of this part of the design process. Therefore, the creation of the standard cell 100 by DPL may conflict with the creation of at least one of the outer cells 110 and 120. Specifically, the gap between adjacent mask features corresponding to the respective cells may be less than that allowed for in the process margin of the lithography process used to form the DPL mask. Furthermore, the ordinarily complex process of dividing the pattern corresponding to that of the standard cell 100 into two patterns for DPL after the cells have been laid out to avoid conflicts with the mask patterns corresponding to those of the outer cells, would be especially time consuming.

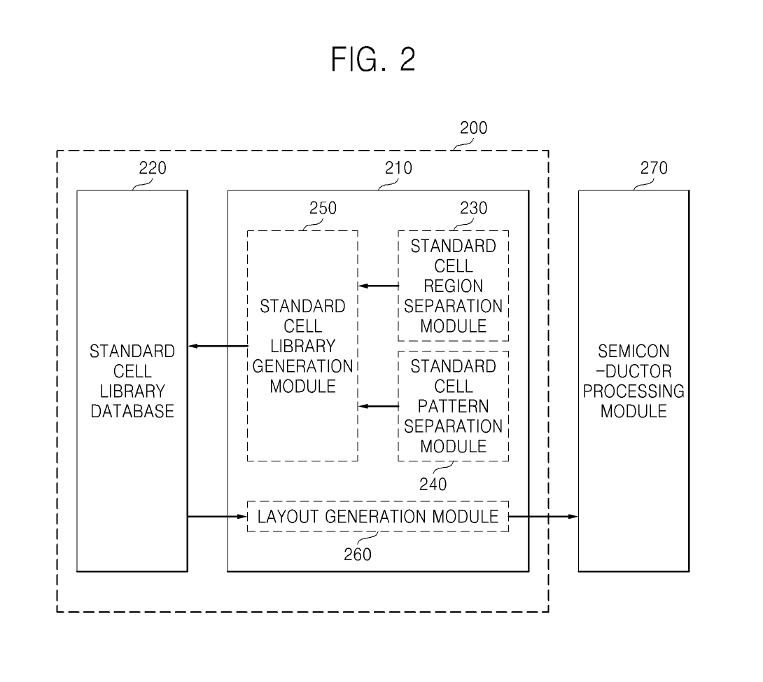

FIG. 2 shows a processing module 270, and a layout generator 200 for generating a standard cell library for use by the module 270 in producing a device using double patterning lithography (DPL), according to the inventive concept.

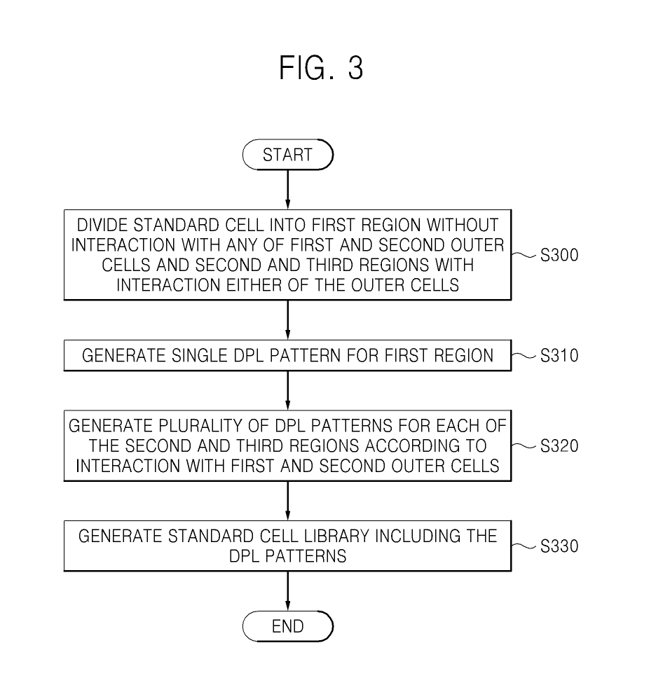

FIG. 3 shows a method of producing a standard cell library according to the inventive concept.

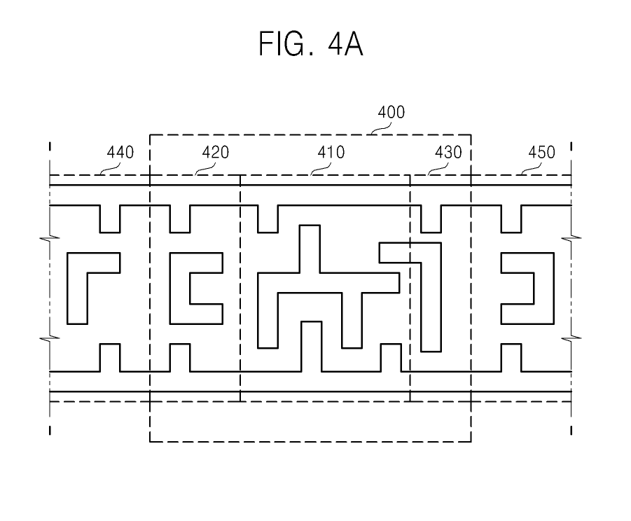

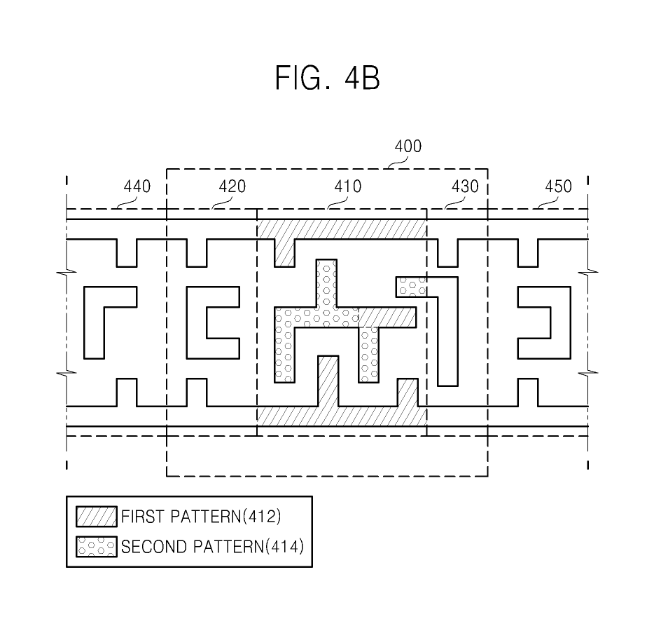

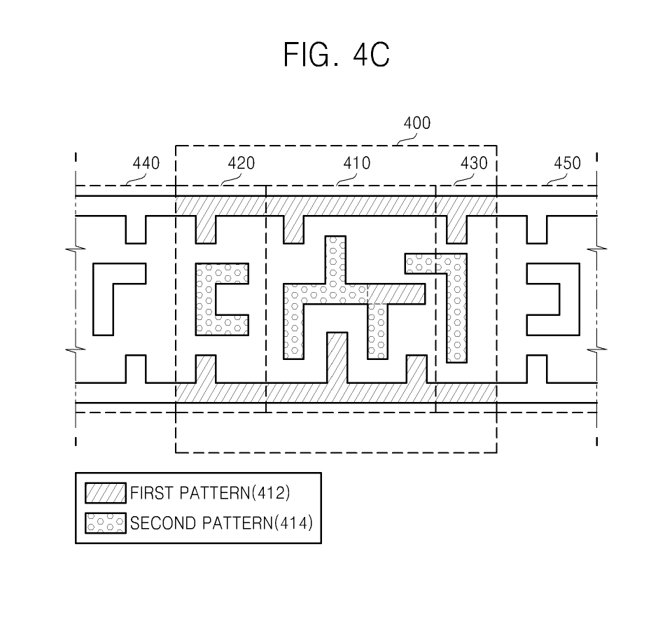

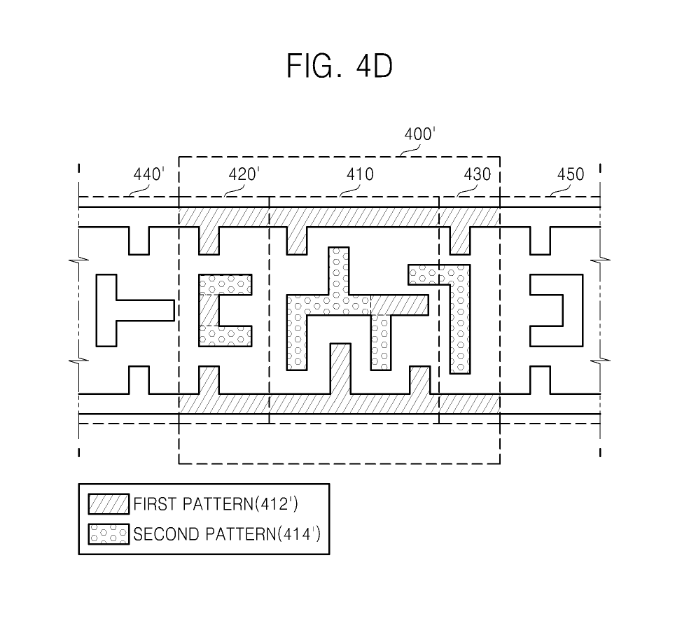

FIGS. 4A through 4D illustrate stages in the method shown in FIG. 3.

Referring to FIGS. 2 and 3 and FIGS. 4A through 4C, the layout generator 200 includes a controller 210 and a standard cell library database 220. The controller 210 includes a standard cell region separation module 230, a standard cell pattern separation module 240, a standard cell library generation module 250, and a layout generation module 260.

The standard cell region separation module 230 performs an operation of analyzing the pattern of the standard cell 400 to discriminate a first region 410 of the standard cell 400, which will not have an interaction with outer cells 440 and 450 when the layout is produced (i.e., during a lithography process), and second and third regions 420 and 430 of the standard cell which will have interactions with the outer cells 440 and 450, respectively, when the layout is produced. Here, the term “interaction” refers to a likelihood that a feature in a particular mask pattern will adversely influence/be influenced by a feature in an adjacent mask pattern when a layout of the cells is produced by lithography, e.g., refers to the fact that a gap between features of mask patterns corresponding to adjacent cells is below the limit imposed by the process margin of the lithography process for producing the cells. The standard cell region separation module 230 is also operative to issue region separation information, representative of the division of the standard cell 400 into the first through third regions 410, 420 and 430, to the standard cell library generation module 250.

The standard cell pattern separation module 240 generates and sends pattern separation information pertaining to each of the first through third regions 410, 420 and 430 to the standard cell library generation module 250. Here, “pattern separation information” refers to data representative of the patterns that each original pattern of the standard cell 400 is to be broken down into for production by DPL, and the distance between adjacent features in each particular region. In this example, the standard cell pattern separation module 240 generates data representative of one DPL pattern corresponding to the first region 410, and a plurality of DPL patterns corresponding to each of the second and third regions 420 and 430. The several patterns corresponding to the second and third regions 420 and 430 are based on the particular interactions that would otherwise take place between the DPL patterns corresponding to the second and third regions 420 and 430 and the DPL patterns corresponding to the outer cells 440 and 450, respectively. That is, the standard cell pattern separation module designs the DPL process for creating the respective regions, of standard cell 400, which have been discriminated from one another by the standard cell region separation module 230.

The standard cell library generation module 250 receives the region separation information (data) from the standard cell region separation module 230 and the pattern separation information (data) from the standard cell pattern separation module 240 and constructs standard cell library data from the information. In this respect, the standard cell library generation module 250 may send the standard cell library data to standard cell library database 220.

When a mask pattern is fabricated by DPL using the standard cell library according to the inventive concept, which will be described later, for each pattern of the mask corresponding to that of the standard cell, the layout generation module 260 selects the DPL pattern corresponding the first region of the standard cell, selects DPL patterns corresponding to the second and third regions of the standard cell based on the patterns producing the cells that are to be disposed adjacent the standard cell, and sends data representative of these DPL patterns to the semiconductor processing module 270.

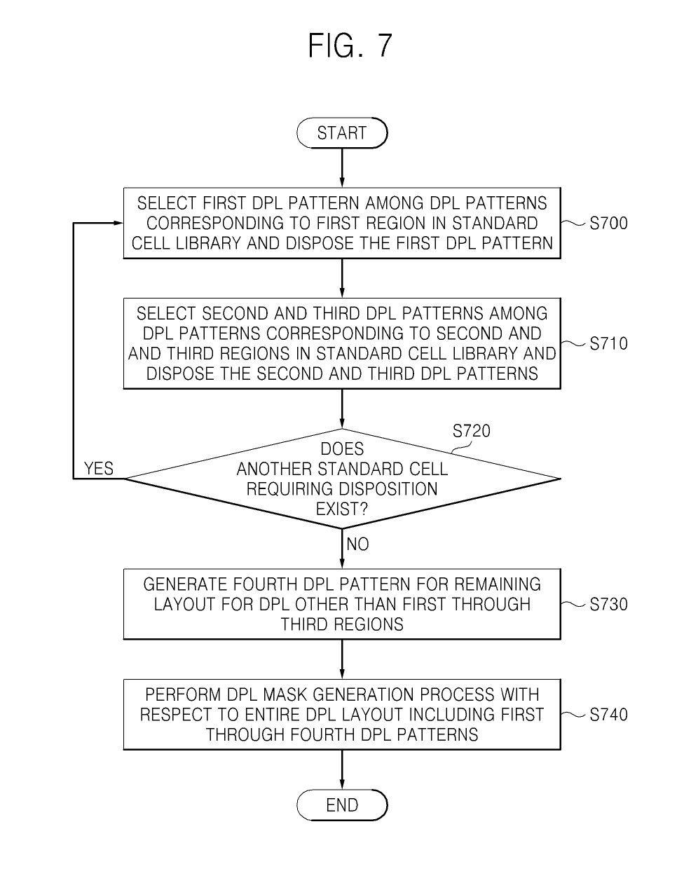

In addition, if it is determined that a standard cell having another type of pattern is necessary, the layout generation module 260 selects appropriate ones of first through third DPL patterns for producing the regions of each additional standard cell, and sends corresponding DPL process data to the semiconductor processing module 270. After the first through third DPL patterns for each standard cell of the layout are determined in this way, the layout generation module 260 may generate a fourth DPL pattern corresponding to a remaining cell(s) (a cell(s) other than the standard cell or cells). The layout generation module 260 may transmit DPL process data for the entire layout to the semiconductor processing module 270. An example of this process will be described in more detail later on with reference to FIG. 7.

The controller 210, which includes the standard cell region separation module 230, the standard cell pattern separation module 240, the standard cell library generation module 250 and the layout generation module 260, may be driven by software (a program) or external hardware including a central processing unit (CPU).

As is clear from the description above, the standard cell library database 220 receives data representing the standard cell library from the standard cell library generation module 250 and stores the standard cell library data in the form of a database. To this end, the standard cell library database 220 may include non-volatile memory, e.g., flash memory, phase-change random access memory (PRAM) or resistive RAM (RRAM), which can retain the data regardless of whether power supplied to the layout generator 200 is interrupted. In addition, at the request of the layout generation module 260, the standard cell library database 220 sends DPL process data for each standard cell to be produced in a layer to the semiconductor processing module 270.

Referring now to FIGS. 2, 3 and 4A, the standard cell region separation module 230 divides the standard cell 400 into the first region 410, and the second and third regions 420 and 430 (operation S300) based on an analysis of the pattern of features of the standard cell 400. As was described above, the first region 410 is a region whose pattern can be produced using mask features which will not have an interaction with the closest features of the mask patterns for forming the first and second outer cells 440 and 450, in a lithography process of producing the cells. The second region 420 is a region having a pattern produced by mask features likely to have an interaction with those used for producing the first outer cell 440, in the lithography process. The third region 430 is a region having a pattern produced by mask features likely to have an interaction with those used for the second outer cell 450, in the lithography process.

Referring to FIGS. 2, 3 and 4B, the standard cell pattern separation module 240 generates the DPL pattern, one time only, for the first region 410 (S310). That is, in operation 5310, the pattern of the first region 410 is broken down into a first pattern 412 and a second pattern 414 corresponding to the pattern of the first region 410 in a DPL process. Only one DPL pattern has to be derived for the first region because wherever the standard cell 400 is disposed in a layout, the DPL pattern corresponding to the first region 410 will not create a conflict with a DPL pattern corresponding to any type of cell adjacent to the standard cell in the layout.

Referring to FIGS. 2, 3, 4C and 4D, the standard cell pattern separation module 240 generates several DPL patterns corresponding to each of the second and third regions 420 and 430 (S320) based on the interactions that may occur between the DPL patterns for forming the patterns of the second and third regions 420 and 430 and those for forming the patterns of the first and second outer cells that may be disposed adjacent thereto, respectively. The DPL patterns corresponding to each of the second region and third regions 420 and 430 are designed to avoid interaction with the DPL patterns corresponding to the respective types (patterns) of outer cells that may be produced adjacent to the regions 420 and 430 in a respective layout in which the standard cell is provided. Specifically, the number of DPL patterns generated in 5310, for producing either of the first and second regions of the standard cell, is at least equal to the number of different types of outer cells that can be adjacent to that region, in a given device, based on the type of the standard cell 400 (e.g., OR, AND, NOR or NAND gate).

FIG. 4C shows one example of a layout in which the standard cell 400 is provided, and in which the first pattern 412 and the second pattern 414 of the DPL pattern are designed (in S310) for the second and third regions 420 and 430 to avoid an interaction with the DPL patterns for the first and second outer cells 440 and 450, respectively.

FIG. 4D shows another example of a layout in which the same type of standard cell 400′ is provided, and in which the first pattern 412 and the second pattern 414 of the DPL pattern are designed (in 5310) to avoid an interaction between the DPL pattern for the second region 420′ of the standard cell 400′ and the DPL pattern for a first outer cell 440′ having a pattern different from that of first outer cell 440.

Comparing the cases shown in FIGS. 4C and 4D, in the layout shown in FIG. 4D a feature of the DPL pattern for the first outer cell 440′ is closer to the border between the first outer cell 440′ and the second region 420′ than in the layout shown in FIG. 4C. Thus, in producing the layout shown in FIG. 4D, if the second region 420′ were produced according to the DPL pattern (first and second patterns 412 and 414) for the second region 420 shown in FIG. 4C, a conflict would occur between adjacent features of the DPL patterns for the second region 420′ and the first outer cell 440′. Therefore, a different DPL pattern (comprising first pattern 412′ which differs from first pattern 412 and second pattern 414′ which is the same as second patter 414, in this example) corresponding to the second region of the standard cell is produced when the layout shows that second region is to be disposed beside any first outer cell 440′.

Referring to FIGS. 2, 3, 4C and 4D, as is clear from the description above, the standard cell region separation module 230 and the standard cell pattern separation module 240 respectively send the region separation information and the pattern separation information regarding the standard cells to the standard cell library generation module 250. The standard cell library generation module 250 produces a standard cell library for DPL by combining information representing the single DPL pattern for the first region 410 selectively with respective ones of the plurality of DPL patterns for each of the second and third regions 420 and 430 (operation S330). This process can be repeated so that a different set of DPL patterns for the second and third regions (e.g., the DPL pattern for second region 420′ and the DPL pattern for the third region 430 shown in FIG. 4D) are associated with the same DPL pattern for the first region 410. The standard cell library generation module 250 may then send the standard cell library to the standard cell library database 220. The standard cell library database 220 stores the standard cell library in the form of a database.

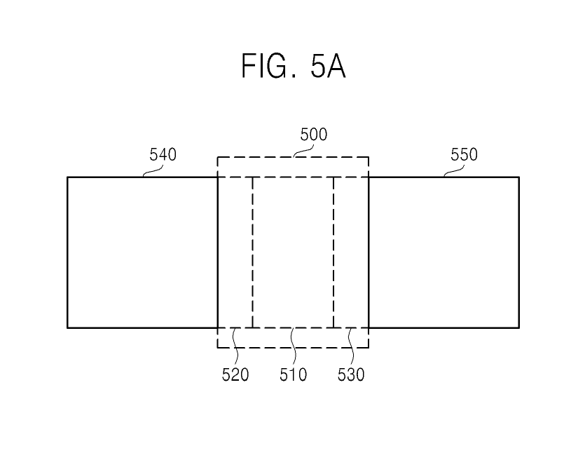

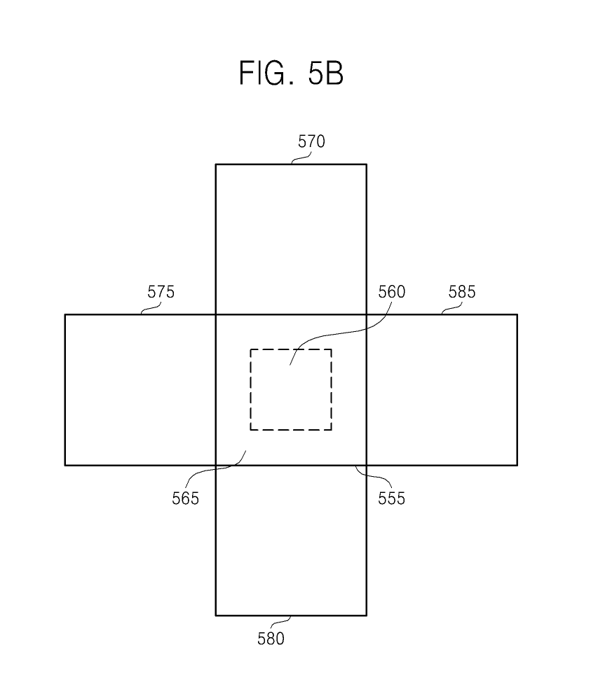

FIGS. 5A and 5B show different ways in which region separation information may be produced, i.e., different ways in which a standard cell may be divided into regions, in a method of generating a standard cell library for DPL according to the inventive concept.

FIG. 5A basically shows an example that has already been used above in connection with the description of the method of FIG. 3. In this example, a first outer cell 540 and a second outer cell 550 are disposed on the left and right sides of a standard cell 500 in the layout (design of the article). In this case, a first region 510 is a region produced by a DPL pattern that will not have an interaction with the DPL patterns for producing the first and second outer cells 540 and 550 (according to the process margin of the lithography process in which the DPL patterns are used as a mask to pattern a target layer). Contrarily, a region of standard cell 500 that is adjacent to the first outer cell 540 and which will be produced by a DPL pattern that will have an interaction with the DPL pattern for forming the first outer cell 540 is discriminated as a second region 520; and a region of standard cell 500 that is adjacent to the second outer cell 550 and which will be produced by a DPL pattern that will have an interaction with the DPL pattern for producing the second outer cell 550 is discriminated as a third region 530. Accordingly, the standard cell 500 is divided into three regions: second and third regions 520 and 530 on the left and right sides, respectively, of the first region 510.

Referring to FIG. 5B, in this layout (design of the article to be manufactured) first through fourth outer cells 570, 575, 580 and 585 are positioned around a standard cell 555. In this case, a region that will be produced by a DPL pattern that will not interact with the DPL pattern for producing the first through fourth outer cells 570, 575, 580 and 585 may be discriminated as a first region 560. Contrarily, a region that is adjacent to the first through fourth outer cells 570, 575, 580 and 585 and that will be produced by a DPL pattern that will interact with a DPL pattern for producing the first through fourth outer cells 570, 575, 580 and 585 is discriminated as a second region 565. Accordingly, the second region 565 surrounds the first region 560. Under the principles of the inventive concept described above, different DPL patterns are created for the second region 565 based on the different possible types of cells that can be positioned around the standard cell 555.

Furthermore, the inventive concept is not limited to the ways shown in FIGS. 5A and 5B in which the standard cell can be divided into a region whose corresponding DPL pattern will not interact with the DPL pattern for any adjacent cell, and one or more regions whose corresponding DPL will have an interaction with the DPL pattern for an adjacent cell. That is, other ways of discriminating the regions are possible depending on the layout of the cells, for example.

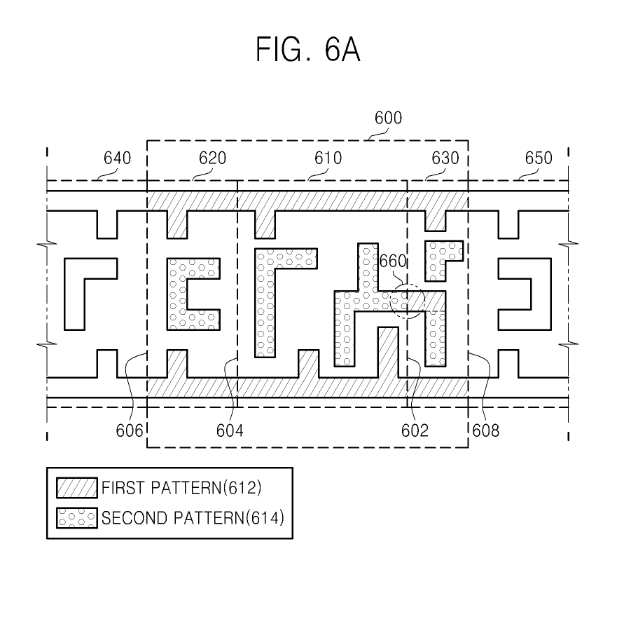

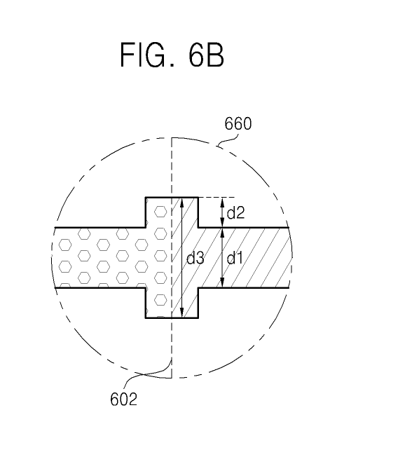

FIGS. 6A and 6B show a stitching technique for a DPL process in accordance with the inventive concept.

Referring to the layout of the DPL patterns shown in FIG. 6A, as a result of designing the DPL patterns for forming cells according to the inventive concept, a first pattern 612 and a second pattern 614 of the DPL pattern may each terminate at roughly the same location as viewed in plan along a border 602 between a first region 610 and a third region 630 of a standard cell 600. In this case, the patterns 612 and 614 may be misaligned at this location or the width of the region where the ends of the two patterns join one another in the layout of the DPL patterns may be less than a critical dimension. As a result, the resistance of a conductive line formed by the DPL process may be excessive at the corresponding location.

To minimize this effect, in designing the DPL patterns, a dimension of a feature of a DPL pattern within a predetermined distance from the border is increased. In this example, the segment of any line feature of the DPL pattern within a predetermined distance from the border 602 between the first region 610 and the third region 630 is designed to have a width d3 that is greater than the width d1 of the segment outside the predetermined distance from the border. The additional width d2 at both sides of the former allows for an optimal stitching according to a design rule, i.e., a DRC rule used in the designing of the layout of the cells.

Although this example has been made with respect to the patterns (612 and 614) at the border 602 between the first region 610 and the third region 630, the technique of enlarging dimensions of segments of features of the patterns may also be applied to the first and second patterns 612 and 614 within a predetermined distance from a border 604 between the first region 610 and a second region 620, a border 606 between the second region 620 and a first outer cell 640, and/or a border 608 between the third region 630 and a second outer cell 650.

FIG. 7 is a flowchart of a method of fabricating a DPL mask using a standard cell library according to the inventive concept. The term “mask” refers to the patterns that are used as a mask throughout the course of a DPL process in which a target layer is patterned. This method will be described in connection with an example in which the pattern of a semiconductor device or the like to be formed using the mask is specified as corresponding to that shown in FIG. 4A.

Referring to FIGS. 2 through 4C and FIG. 7, the layout generation module 260 selects a first DPL pattern corresponding to the first region 410 of standard cell 400 from among DPL patterns stored in the standard cell library database 220 and generates data indicative of a relative position of the first DPL pattern (operation S700).

The layout generation module 260 also selects a second DPL pattern corresponding to the second region 420 of the current standard cell 400 and a third DPL pattern corresponding to the third region 430 of the current standard cell 400 from among a plurality of DPL patterns stored in the standard cell library database 220 and generates date indicative of the positioning of the second and third DPL patterns at opposite sides of the first DPL pattern (S710). At this time, the layout generation module 260 selects the second and third DPL patterns from the standard cell library database 220 based on the pattern of the first outer cell 440 and the pattern of the third region 430 considering the potential for interaction between (features of) the DPL pattern corresponding to the second region 420 and (features of) the DPL pattern corresponding to the first outer cell 440, and the potential for interaction between (features of) the DPL pattern corresponding to the third region 430 and the (features of) the DPL corresponding to the second outer cell 450.

A plurality of standard cells may be present throughout the layout. Accordingly, after selecting the first through third DPL patterns and in effect setting the relative positions where the first through third DPL patterns will be formed, the layout generation module 260 determines whether another standard cell is present somewhere in the layout (S720). If so, the layout generation module 260 repeats operations S700 and S710. If not, the layout generation module 260 generates a fourth DPL pattern (S730) that will produce the remainder of the layout, including the first outer cell 440 and the second outer cell 450, in a DPL process.

Finally, the layout generation module 260 transmits information on the entire layout of the DPL patterns to the semiconductor processing module 270 and the semiconductor processing module 270 fabricates a DPL mask for use in a DPL process based on the layout information (S740). The DPL process may be a double exposure process or a self-aligned sidewall spacer forming process.

According to an aspect of the inventive concept as described above, a standard cell in a layout of cells is divided into at least one outer region that has the potential for creating conflict with an adjacent cell in connection with a DPL process of forming the cells, and an inner region that has substantially no potential conflict with an adjacent cell. Then DPL patterns that can be used to produce the patterns of the regions of the standard cell are selected from a database, with the DPL pattern(s) corresponding to at least one outer region being each selected from among several DPL patterns based on the pattern of the cell/cells that is/are to be formed adjacent to the outer region(s). Accordingly, the DPL patterns corresponding to the standard cells in the layout can be determined quickly. Moreover, a DPL mask that can produce an accurate pattern in an underlying target layer, i.e., a DPL mask that will produce well defined features, can be fabricated quickly.

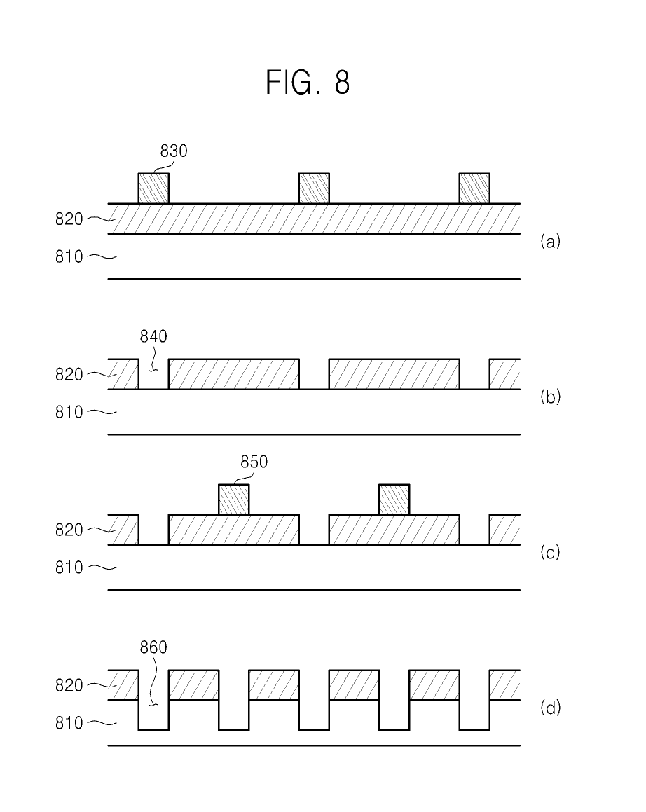

FIG. 8 shows a double exposure process as an example of a method in which a DPL mask is fabricated using a standard cell library according the inventive concept. The method will be described with respect to the forming of a mask pattern corresponding to that shown in FIG. 4C, and wherein the DPL pattern information has been generated according to the inventive concept by a generator 200 of the type shown in and described with reference to FIG. 2 and delivered to processing module 270.

Referring to FIGS. 4C and 8, the double exposure process allows the pitch of a pattern that can be formed using a conventional lithography (single exposure process) to be reduced or “split”. A photoresist layer 820 is formed on an underlying layer to be patterned. The underlying layer may be a target layer 810 formed on a substrate (not shown) in which case the photoresist layer 820 is formed on the target layer 810. A first target pattern 830 corresponding to the first pattern 412 is formed by the processing module 270 on the photoresist layer 820. Then a first trench 840 is formed in the photoresist layer 820 by exposing and developing (e.g., dry etching) the photoresist layer 820. In this example, the first target pattern 830 is used as a mask (i.e., one part of the DPL mask) during the exposure process, and the unexposed part of the photoresist layer 820 and the first target pattern 830 are subsequently removed by an etching process.

Next, a second target pattern 850 corresponding to the second pattern 414 is formed on the photoresist layer 820. A second trench (not shown) is formed in the photoresist layer 820 beneath the second target pattern 850 using exposure and developing processes similar to those described above, wherein the second target pattern 850 is used as a mask (the other part of the DPL mask). The portions of the target layer 810 exposed by the first and second trenches are then etched to form a third trench 860 having segments spaced apart in a given direction and whose pitch, in this example, is a fraction (e.g., half) of that of each of the first and second target patterns 830 and 850. Thus, a mask pattern having a fine pitch is produced in the target layer.

When the DPL process is used to form a wiring pattern, for example, on the surface of a substrate of a CPU (e.g., a printed circuit board) or a high-density semiconductor device such as a volatile or non-volatile semiconductor memory device, conflict between adjacent features of the mask pattern for forming the wiring pattern in a DPL process is avoided and the resolution of the lithography process is in effect increased. Therefore, the time and cost associated with the so-called “pattern separation for double patterning” is reduced when the process for forming a layout of cells, including a standard cell, is designed.

Finally, embodiments of the inventive concept and examples thereof have been described above in detail. The inventive concept may, however, be embodied in many different forms and should not be construed as being limited to the embodiments described above. Rather, these embodiments were described so that this disclosure is thorough and complete, and fully conveys the inventive concept to those skilled in the art. Thus, the true spirit and scope of the inventive concept is not limited by the embodiment and examples described above but by the following claims.

What is claimed is:

1. A method of generating a standard cell library for double patterning lithography (DPL), the method comprising the operations of:
analyzing a pattern of a standard cell, that is to occur in multiples in a device to be fabricated using a DPL process, to yield a first region and a second region of the standard cell,
wherein the first region is one having a pattern that can be produced by a DPL process without conflicting with the production of any respective one of several different patterns of outer cells each of which can be produced adjacent the standard cell during the DPL process, and the second region is one having a pattern that when produced by the DPL process has a substantial likelihood of conflicting with the production of any of the several different patterns of the outer cells when produced adjacent the standard cell during the DPL process;
generating data representative of DPL patterns corresponding to each of the first and second regions; and
creating a standard cell library comprising the data representative of the DPL patterns.

2. The method of claim 1, wherein the generating the data of the DPL patterns comprises:
generating data representative of a single DPL pattern corresponding to the pattern of the first region; and
generating data representative of a plurality of DPL patterns each corresponding to the pattern of the second region and each according to its potential conflict with the production of a respective one of the several different patterns of the outer cells in the DPL process.

3. The method of claim 2, wherein the potential conflict is determined by the existence of a feature of the pattern of the standard cell within a certain proximity to a feature of the pattern of the outer cell.

4. The method of claim 1, wherein the second region surrounds the first region.

5. The method of claim 1, wherein the generating of data representative of DPL patterns corresponding to each of the first and second regions comprises generating first data representative of a first part of a DPL pattern located within a predetermined distance from a border between the first region and the second region, and second data representative of a second part of a DPL pattern located within the predetermined distance from a border between the second region and the outer cell to be produced adjacent to the standard cell during the DPL process, and wherein the first and second parts of the DPL pattern located the predetermined distance from the respective borders are wider than remaining parts of the DPL pattern contiguous with the first and second parts, respectively.

6. The method of claim 5, wherein the predetermined distance is based on a design rule of the DPL process.

7. A computer readable recording medium comprising a database configured with the standard cell library generated by the method of claim 1.

8. A method of producing a double patterning lithography (DPL) mask, the method comprising:
providing a cell library having data representative of DPL patterns corresponding to patterns of first and second regions of a standard cell;
selecting data representative of a first DPL pattern corresponding to the pattern of the first region of the standard cell from the cell library and determining a position of where the first DPL pattern is to be produced on an underlying layer in a DPL process for forming respective patterns of cells of the device;
selecting data representative of a second DPL pattern corresponding to the pattern of the second region of the standard cell from the cell library and determining a position of where the second DPL pattern is to be produced on the underlying layer in the DPL process, the second region being one having a pattern that when produced by the DPL process has a substantial likelihood of conflicting with the production of any of the several different patterns of the outer cells when produced adjacent the standard cell during the DPL process;
determining a position of where a third DPL pattern corresponding to a pattern of another cell is to be produced on the underlying layer in the DPL process; and
forming a DPL mask comprising the first, second and third DPL patterns on the underlying layer.

9. The method of claim 8, wherein the forming of the DPL mask constitutes a double exposure process in which a resist layer is formed on the underlying layer, the first mask pattern is formed on the resist layer, and subsequently the second mask pattern is formed on the resist layer offset relative to the first mask pattern, and the resist layer is exposed and etched.

10. The method of claim 8, wherein the providing of the standard cell library comprises constructing the standard cell library according to the method of claim 1.

11. The method of claim 8, wherein the providing of the standard cell library comprises constructing the standard cell library according to the method of claim 3.

12. The method of claim 8, wherein the standard cell library has data representative of only one DPL pattern corresponding to the pattern of the first region and data representative of a plurality of different DPL patterns each corresponding to the pattern of the second region.

13. The method of claim 8, wherein the providing of the standard cell library comprises constructing the standard cell library by the method of claim 4.

14. The method of claim 8, wherein the providing of the standard cell library comprises constructing the standard cell library by the method of claim 5.

15. A method of fabricating a circuit on a substrate, comprising: forming the DPL mask by the method of claim 8, and etching the underlying layer in a DPL process in which the first and second mask patterns are each used as a mask.

16. A method of forming a pattern on a surface of a substrate, comprising:
creating a layout of cells each having a pattern, wherein the cells include a standard cell whose pattern is duplicated at several locations in the layout, and another cell whose pattern exists adjacent to one of the patterns of the standard cell in the layout, the second region being one having a pattern that when produced by the DPL process has a substantial likelihood of conflicting with the production of any of the several different patterns of the outer cells when produced adjacent the standard cell during the DPL process;
providing a cell library having data representative of DPL patterns corresponding to patterns of first and second regions of the standard cell;
selecting data representative of a first DPL pattern corresponding to the pattern of the first region of the standard cell from the cell library and determining several relative positions of where the first DPL pattern is to be produced on an underlying layer in a DPL process for forming the layout of cells;
selecting data representative of a second DPL pattern corresponding to the pattern of the second region of the standard cell from the cell library, and determining a relative position of where the second DPL pattern is to be produced on the underlying layer in the DPL process;
determining a relative position of where a third DPL pattern corresponding to a pattern of another cell is to be produced on the underlying layer in the DPL process;
performing the DPL process including forming the first, second and third DPL patterns relative to one other at said positions on the underlying layer, respectively.

17. The method of claim 16, wherein the DPL process is a double exposure process and further comprises forming a resist layer on the underlying layer, and wherein the first mask pattern is formed on the resist layer, and subsequently the second mask pattern is formed on the resist layer offset relative to the first mask pattern, and the resist layer is exposed and etched.

18. The method of claim 16, wherein the providing of the standard cell library comprises constructing the standard cell library according to the method of claim 1.

19. The method of claim 16, wherein the standard cell library has data representative of only one DPL pattern corresponding to the pattern of the first region and data representative of a plurality of different DPL patterns each corresponding to the pattern of the second region.

20. The method of claim 16, wherein the cell library comprises first data representative of a first part of a DPL pattern located within a predetermined distance from a border between the first region and the second region, and second data representative of a second part of a DPL pattern located within the predetermined distance from a border between the second region and the outer cell to be produced adjacent to the standard cell during the DPL process, and wherein the first and second parts of the DPL pattern located the predetermined distance from the respective borders are wider than remaining parts of the DPL pattern contiguous with the first and second parts, respectively.
